(19) United States
(12) Patent Application Publication
(10) Pub. No.: US 2006/0033555 A1
(43) Pub. Date: Feb. 16, 2006

(54) Voltage regulator

(76) Inventor: Srinath Sridharan, Austin, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/909,849

(22) Filed: Aug. 2, 2004

(51) Int. Cl. G05F 1/10

(52) U.S. Cl. 327/540

(57) ABSTRACT

A voltage regulator configured to provide a regulated voltage to a load having a first conductance is provided. The voltage regulator comprises a feedback circuit configured to generate the regulated voltage and a frequency compensation circuit comprising a first MOSFET device having a second conductance. The frequency compensation circuit is configured to operate the first MOSFET device so that the second conductance varies in response to the first conductance of the load.

### BACKGROUND

Voltage regulators typically provide a regulated voltage to a load using a reference voltage. FIG. 1 illustrates a generalized voltage regulator 10 according to the prior art in which an amplifier 12, a feedback circuit 14, and a MOSFET device 16 provide a regulated voltage, V_{reg}, to a load 18 (represented by a load current I_{L}) using a reference voltage V_{ref} and a supply voltage V_{dd}. More particularly, amplifier 12 provides a voltage to the gate of MOSFET device 16 in response to the reference voltage and a negative feedback voltage provided by feedback circuit 14. The voltage at the gate of MOSFET device 16 allows a relatively constant current, I_{L}, to flow from MOSFET device 16 to load 18 and generates the regulated voltage at the drain of MOSFET device 16. The regulated voltage feeds into feedback circuit 14 to generate the negative feedback voltage.

Voltage regulator 10 as shown in FIG. 1 may be designed such that the regulated voltage is relatively insensitive to process, temperature, and supply voltage variations. In addition, voltage regulator 10 may employ frequency compensation or stabilization techniques to ensure stability of the feedback system of voltage regulator 10. Many frequency compensation techniques, however, assume a relatively constant load current for voltage regulator 10. If the load current of voltage regulator 10 varies significantly, voltage regulator 10 may become unstable even where frequency compensation techniques are employed.

It would be desirable to be able to provide a voltage regulator that remains stable in response to varying load currents.

### SUMMARY

According to one exemplary embodiment, a voltage regulator configured to provide a regulated voltage to a load having a first conductance is provided. The voltage regulator comprises a feedback circuit configured to generate the regulated voltage and a frequency compensation circuit comprising a first MOSFET device having a second conductance. The frequency compensation circuit is configured to operate the first MOSFET device so that the second conductance varies in response to the first conductance of the load.

In another exemplary embodiment, a method performed by a voltage regulator is provided. The method comprises providing a regulated voltage to a load having a first conductance and compensating for first variations in the first conductance of the load.

In yet another exemplary embodiment, a system comprising a functional unit having a first conductance and a voltage regulator comprising a first circuit configured to provide a regulated voltage to the functional unit and a second circuit comprising a first MOSFET device having a second conductance is provided. The second circuit is configured to operate the first MOSFET device so that the second conductance tracks the first conductance of the functional unit.

A further exemplary embodiment provides a voltage regulator for providing a regulated voltage to a load having a first conductance comprising a circuit configured to provide the regulated voltage to the load, first means for generating a second conductance, and second means for operating the first means so that the second conductance tracks the first conductance of the load.

### BRIEF DESCRIPTION OF THE DRAWINGS

FIG. 1 is a circuit diagram illustrating a voltage regulator according to the prior art.

FIG. 2 is a block diagram illustrating an embodiment of a system that includes a voltage regulator.

FIG. 3 is a circuit diagram illustrating an embodiment of a voltage regulator connected to a functional unit.

FIG. 4 is a circuit diagram illustrating an embodiment of a portion of the voltage regulator shown in FIG. 3.

FIG. 5 is a circuit diagram illustrating an embodiment of a portion of the voltage regulator shown in FIG. 3.

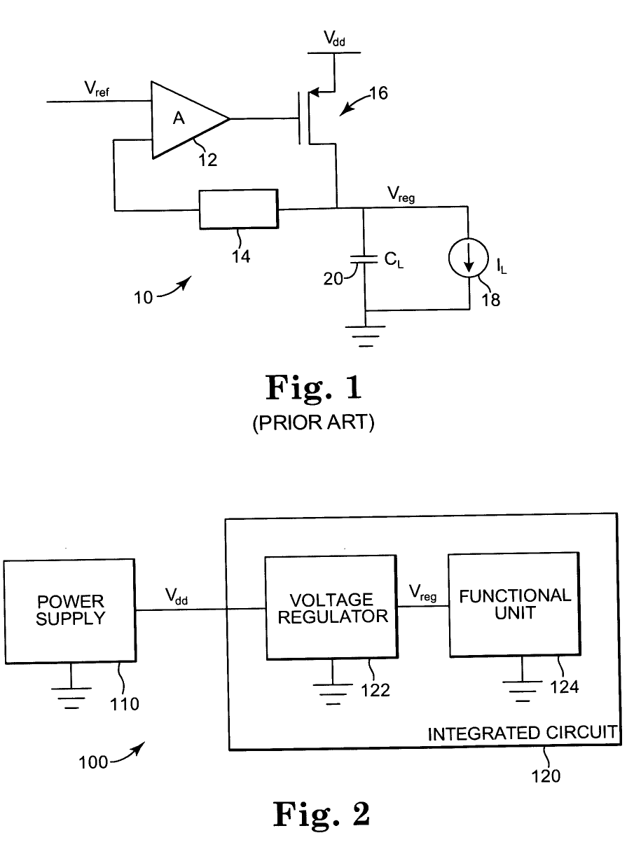

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

FIG. 2 is a block diagram illustrating an embodiment of selected portions of a system 100 that includes a voltage regulator 122. System 100 comprises a power supply 110 and an integrated circuit (IC) 120 which receives a supply voltage V_{dd} from power supply 110. IC 120 comprises voltage regulator 122 and a functional unit 124 which receives a regulated voltage V_{reg} from voltage regulator 122.

Functional unit 124 comprises a circuit configured to perform one or more functions in system 100 using the regulated voltage provided by voltage regulator 122. Other functional units in the system (not shown) may perform the same or different functions as those performed by functional unit 124. Functional unit 124 presents a load configured to draw varying load currents from voltage regulator 122. In one embodiment, functional unit 124 may be a part of a wireless communication transceiver for use in a GSM (Global System for Mobile Communications) network. In other embodiments, functional unit 124 may be another type of transceiver or another type of electronic device configured to perform other types of functions.

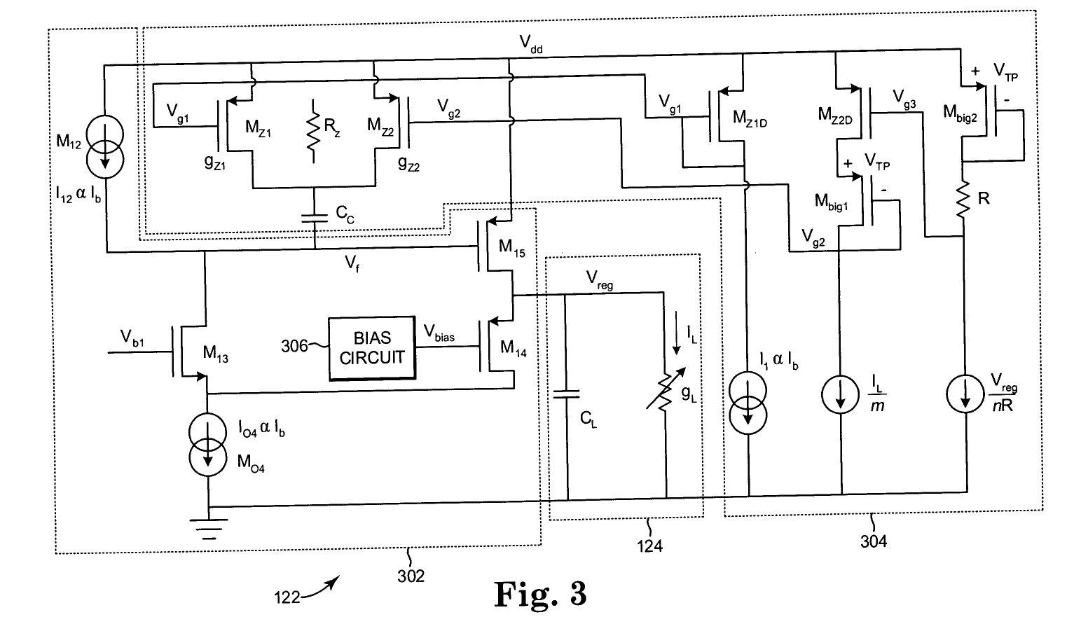

FIG. 3 is a circuit diagram illustrating an embodiment of voltage regulator 122 coupled to functional unit 124. In FIG. 3, voltage regulator 122 connects to the supply voltage V_{dd} provided by power supply 110 to provide a regulated voltage V_{reg} to functional unit 124 which is represented by a variable load conductance g_{L} and a capacitive load element C_{L} in FIG. 3. Voltage regulator 122 comprises a feedback circuit 302 configured to provide the regulated voltage to the load of functional unit 124 and a frequency compensation circuit 304 configured to stabilize voltage regulator 122 in response to frequency and load current variations from functional unit 124.

Feedback circuit 302 comprises a MOSFET device M₁₂ configured to operate as a current source I₁₂, an n-channel MOSFET device M₁₃, a p-channel MOSFET device M₁₄, a p-channel MOSFET device M₁₅, a MOSFET device M_{O4} configured to operate as a current source I_{O4}, and a bias circuit 306.

The supply voltage is provided to MOSFET device M₁₂ and the source connection of MOSFET device M₁₅. MOSFET device M₁₂ connects to the gate connection of MOSFET device M₁₅ and the drain connection of MOSFET device M₁₃. The drain connection of MOSFET device M₁₅ connects to functional unit 124 and the source connection of MOSFET device M₁₄. The drain connection of MOSFET device M₁₄ connects to MOSFET device M_{O4} and the source connection of MOSFET device M₁₃. MOSFET device M_{O4} and the capacitive load element C_{L} also connect to a ground node. A voltage V_{b1} is provided to the gate connection of MOSFET device M₁₃, and a voltage V_{bias} is provided to the gate connection of MOSFET device M₁₄.

MOSFET device M₁₅ provides the load current I_{L} to functional unit 124 in response to a feedback voltage V_{f} at the gate connection of MOSFET device M₁₅. MOSFET device M₁₅ also provides a feedback current I₁₄ through MOSFET device M₁₄ in response to a bias voltage V_{bias}. The bias voltage V_{bias} is generated by bias circuit 306 to operate MOSFET device M₁₄ in a saturation region of MOSFET device M₁₄. Additional details of bias circuit 306 are described according to one embodiment with reference to FIG. 5 below.

MOSFET device M₁₂ provides a current source I₁₂ which flows through MOSFET devices M₁₃ and M_{O4} to cause the feedback voltage V_{f} to be provided to the gate connection of MOSFET device M₁₅. A bias voltage V_{b1} is provided to MOSFET device M₁₃ to cause MOSFET device M₁₃ to be operated in a saturation region. MOSFET device M_{O4} provides a current source I_{O4} to draw current from MOSFET devices M₁₃ and M₁₄.

Frequency compensation circuit 304 comprises a capacitive element C_{C}, a first portion configured to compensate for the varying transconductance of MOSFET device M₁₄ (g_{M14}), and a second portion configured to compensate for the varying conductance of the load (g_{L}).

The first portion of frequency compensation circuit 304 comprises a p-channel MOSFET device M_{Z1} and a biasing circuit configured to provide a bias voltage V_{g1} to MOSFET device M_{Z1}. The biasing circuit comprises a p-channel MOSFET device M_{Z1D}, and a current source I₁. The source connection of MOSFET device M_{Z1} is connected to the supply voltage, and the drain connection of MOSFET device M_{Z1} is connected to the capacitive element C_{C}. The capacitive element C_{C} also connects to the gate connection of MOSFET M₁₅. The source connection of MOSFET device M_{Z1D} connects to the supply voltage, and MOSFET device M_{Z1D} is connected to operate as a diode (i.e., the gate connection is connected to the drain connection). Current source I₁ connects between the drain connection of MOSFET device M_{Z1D} and a ground node to produce the bias voltage V_{g1} at the gate and drain connections of MOSFET device M_{Z1D}. The bias voltage V_{g1} is provided to the gate connection of MOSFET device M_{Z1}.

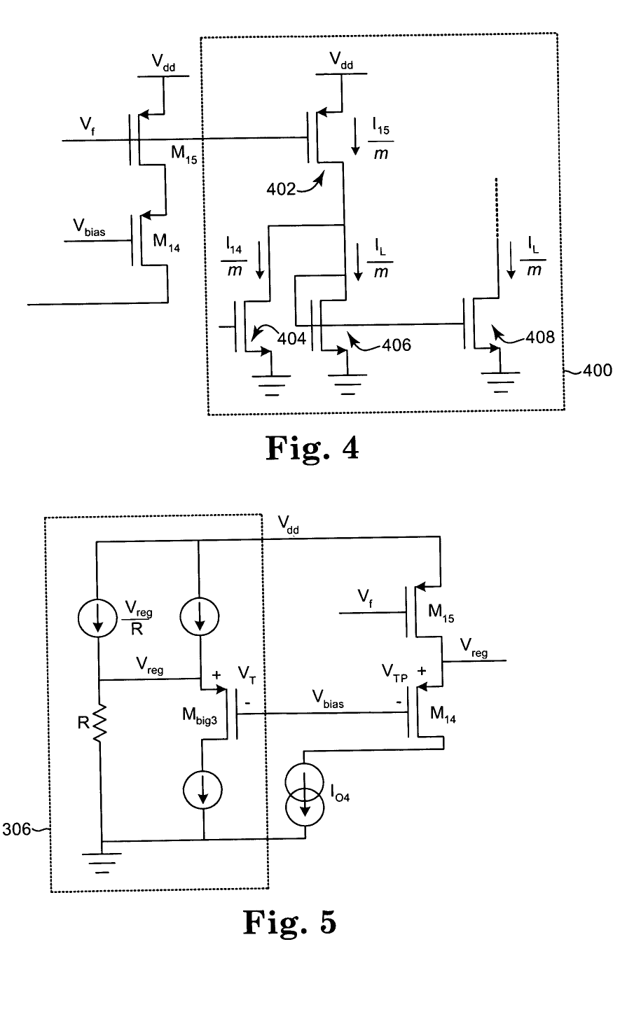

The second portion of frequency compensation circuit 304 comprises a p-channel MOSFET device M_{Z2} and a biasing circuit configured to provide a bias voltage V_{g2} to MOSFET device M_{Z2}. The biasing circuit comprises a p-channel MOSFET device M_{Z2D}, two relatively large p-channel MOSFET devices M_{big1} and M_{big2}, a current source I_{L}/m, a current source V_{reg}/nR, and a resistive element R. The source connection of MOSFET device M_{Z2} is connected to the supply voltage and the drain connection of MOSFET device M_{Z2} is connected to capacitive element C_{C}. The source connection of MOSFET device M_{Z2D} connects to the supply voltage. The drain connection of MOSFET device M_{Z2D} connects to the source connection of MOSFET device M_{big1}. MOSFET device M_{big1} is connected to operate as a diode (i.e., the gate connection is connected to the drain connection). The source connection of MOSFET device M_{big2} connects to the supply voltage, and the drain connection of MOSFET device M_{big2} connects to a first end of resistive element R. MOSFET device M_{big2} is connected to operate as a diode (i.e., the gate connection is connected to the drain connection). Current source V_{reg}/nR connects to a second end of resistive element R to produce a gate voltage V_{g3} at the gate connection of MOSFET device M_{Z2D}. The derivation of current source V_{reg}/nR according to one embodiment is described below with reference to FIG. 5. Current source I_{L}/m connects between the gate and drain connections of MOSFET device M_{big1} and a ground node to produce bias voltage V_{g2} at the gate and drain connections of MOSFET device M_{big1}. The derivation of current source I_{L}/m according to one embodiment is described below with reference to FIG. 4. The bias voltage V_{g2} is provided to the gate connection of MOSFET device M_{Z2}.

Because MOSFET devices M_{big1} and M_{big2} are relatively large devices, the source-to-gate voltage of each device approaches the threshold voltage V_{TP}.

As will now be described, frequency compensation circuit 304 operates to cause the conductance of MOSFET device M_{Z1} to track the transconductance of MOSFET device M₁₄ (g_{M14}) and to cause the conductance of MOSFET device M_{Z2} to track the conductance of the load (g_{L}). By doing so, frequency compensation circuit 304 ensures that the regulated voltage V_{reg} provided by feedback circuit 302 remains constant over a relatively wide range of load current I_{L}.

By breaking the feedback loop and applying an initial voltage at the gate of MOSFET device M₁₅, the loop gain equation of voltage regulator 122 may be derived to identify the dominant pole, the non-dominant pole, the DC gain, and the zero of voltage regulator 122 as shown in Equations I-IV, respectively. In the equations below, R_{Z} represents the combined resistance across the MOSFET devices M_{Z1} and M_{Z2}.

$$\begin{matrix}DOMINANTPOLE = \frac{1}{2 π {R}_{M12} {C}_{C}} & Equation I \\ NON \text{-} DOMINANTPOLE = \frac{{g}_{M14} + {g}_{L}}{{C}_{L}} & Equation II \\ DCGAIN = \frac{{g}_{M15} {g}_{M14} {R}_{M12}}{{g}_{M14} + {g}_{L}} & Equation III \\ ZERO = \frac{1}{{R}_{Z} {C}_{C}} & Equation IV\end{matrix}$$

To enhance the phase margin and gain margins of voltage regulator 122, the zero may be set equal to the non-dominant pole as shown in Equation V.

$$\frac{1}{{R}_{Z} {C}_{C}} = \frac{{g}_{M14} + {g}_{L}}{{C}_{L}} \qquad Equation V$$

Equation V may be solved for the combined conductance of MOSFET devices M_{Z1} and M_{Z2} (g_{Z}) to derive Equation VI.

$${g}_{Z} = \frac{{C}_{C}}{{C}_{L}} ( {g}_{M14} + {g}_{L} ) \qquad Equation VI$$

Equation VII may be derived from Equation VI by assuming that C_{C}=C_{L}.
g_{Z}=g_{M14}+g_{L} Equation VII

From Equation VII, the conductance of MOSFET device M_{Z1} (g_{Z1}) is configured to track the transconductance of M₁₄ (g_{M14}). In voltage regulator 122, the current through MOSFET device M₁₂, the current through MOSFET device M_{O4}, and the current I₁ are based on the same master reference bias current (I_{b}) and all track each other. Accordingly, Equations VIII through X may be derived.
I₁₂=I₁₃∝I_{b} Equation VIII
I₁₃+I₁₄=I_{O4}∝I_{b} Equation IX
I₁₅=I₁₄+I_{L} Equation X

Because the above currents are based on the same master reference bias current I_{b} and all track each other, the currents I_{M14} and I₁ are set up to track each other. The transconductance of MOSFET device M₁₄ in the saturation region of operation and the conductance of the load in the saturation region of operation are shown in Equations XI and XII, respectively.

$$\begin{matrix}{g}_{M14} = \sqrt{2 {I}_{14} {μ}_{p} {{C}_{OX} ( \frac{W}{L} )}_{{M}_{14}}} & Equation XI \\ {g}_{L} = \frac{{I}_{L}}{{V}_{reg}} & Equation XII\end{matrix}$$

Because the currents I₁ and I_{M14} track each other, the transconductance of MOSFET device M_{Z1D} tracks the transconductance of MOSFET device M₁₄. Accordingly, the conductance of MOSFET device M_{Z1} in the linear region is set equal to the transconductance of MOSFET device M_{Z1D} in the saturation region of operation as indicated in Equation XIII where μₚ is the average carrier mobility of MOSFET device M_{Z1D}, C_{OX} is the gate oxide capacitance of MOSFET device M_{Z1D}, W is the channel width of MOSFET device M_{Z1D}, and L is the channel length of MOSFET device M_{Z1D}. In addition, MOSFET device M_{Z1D} sets up the gate voltage V_{g1} to cause MOSFET device M_{Z1} to be operated in its linear region.

$${g}_{Z1} = {g}_{Z1D} = \sqrt{2 {I}_{1} {μ}_{p} {{C}_{OX} ( \frac{W}{L} )}_{{M}_{Z1D}}} = {g}_{M14} \qquad Equation XIII$$

By setting the conductance of MOSFET device M_{Z1} equal to the transconductance of MOSFET device M_{Z1D} in the saturation region of operation, the conductance of MOSFET device M_{Z1} tracks the transconductance of MOSFET device M₁₄.

Referring back to Equation VII, the conductance of MOSFET device M_{Z2} (g_{Z2}) is configured to track the conductance of the load of functional unit 124 (g_{L}). The conductance of MOSFET device M_{Z2} in the linear region of operation is expressed in Equation XIV where μₚ is the average carrier mobility of MOSFET device M_{Z2}, C_{OX} is the gate oxide capacitance of MOSFET device M_{Z2}, W is the channel width of MOSFET device M_{Z2}, and L is the channel length of MOSFET device M_{Z2}. MOSFET device M_{Z2} is selected such that its size is

$$m ( \frac{W}{L} ) ,$$

and MOSFET device M_{Z2D} is selected such that its size is

$$n ( \frac{W}{L} ) . \\ {g}_{Z2} = m {μ}_{p} {C}_{OX} ( \frac{W}{L} ) ( {V}_{dd} - {V}_{g2} - \vert {V}_{TP} \vert ) \qquad Equation XIV$$

Because MOSFET devices M_{big1} and M_{big2} are relatively large devices, the source-to-gate voltage of each device approaches the threshold voltage V_{TP} which allows Equations XV and XVI to be derived.

$$\begin{matrix}{V}_{g2} = {V}_{dd} - \vert {V}_{TP} \vert - ( ( \frac{{I}_{L}}{m} ) {R}_{MZ2D} ) & Equation XV \\ \begin{matrix}{R}_{MZ2D} = \frac{1}{n {μ}_{p} {C}_{OX} ( \frac{W}{L} ) ( {V}_{dd} - \vert {V}_{TP} \vert - ( {V}_{dd} - \vert {V}_{TP} \vert - \frac{{V}_{reg}}{n} ) )} \\ = \frac{1}{{g}_{MZ2D}}\end{matrix} & Equation XVI\end{matrix}$$

By substituting Equations XV and XVI into Equation XIV and reducing terms, Equation XVII is derived.

$${g}_{Z2} = \frac{{I}_{L}}{{V}_{reg}} = {g}_{L} \qquad Equation XVII$$

Accordingly, the conductance of MOSFET device M_{Z2} tracks the conductance of the load g_{L} of functional unit 124. MOSFET device M_{Z2D} is biased in its linear region of operation to cause it to behave like a resistor whose value is given by Equation XVI. To ensure that MOSFET device M_{Z2D} is biased in its linear region of operation, MOSFET device M_{Z2D} is operated such that the condition in Equation XVIII holds true.

$$( \frac{{I}_{L}}{m} ) {R}_{MZ2D} {V}_{dd} - {V}_{g3} - \vert {V}_{TP} \vert \qquad Equation XVIII$$

By solving for I_{L}, Equation XVIII may be reduced to Equation XIX.

$${I}_{L} {m ( {V}_{reg} )}^{2} ( μ {pC}_{OX} ( \frac{W}{L} ) ) \qquad Equation XIX$$

Accordingly, MOSFET device M_{Z2D} is biased in its linear region of operation as long as the maximum value of the load current remains substantially below the value calculated on the right side of Equation XIX. The maximum value of the load current may remain substantially below the value calculated on the right side of Equation XIX by selecting appropriate values of W, L, and m for MOSFET device M_{Z2D}.

By selecting appropriate MOSFET devices for devices M_{Z1}, M_{Z1D}, M_{Z2}, and M_{Z2D} in the zero circuit, as described above, Equation XX holds true and the zero of voltage regulator 122 tracks the non-dominant pole over process, temperature, supply voltage, and load current variations. Accordingly, voltage regulator 122 may be stabilized over relatively wide variations of load current for functional unit 124.
g_{Z}=g_{Z1}+g_{Z2}=g_{M14}+g_{L} Equation XX

FIG. 4 illustrates an embodiment of a circuit 400 used to generate current source I_{L}/m in voltage regulator 122. In the embodiment of FIG. 4, current source I_{L}/m is derived by mirroring the current of MOSFET device M₁₅. More particularly, the feedback voltage V_{f} is provided to the gate connection of a p-channel MOSFET device 402. The source connection of MOSFET device 402 is connected to the supply voltage and the drain connection of MOSFET device 402 is connected to the drain connections of n-channel MOSFET devices 404 and 406. The drain and gate connections of MOSFET device 406 are connected to operate MOSFET device 406 as a diode, and the gate connection of MOSFET device 406 is connected to the gate connection of a MOSFET device 408. The drain connection of MOSFET device 408 is connected to the gate and drain connections of MOSFET device Mbig1 (shown in FIG. 3). The source connections of MOSFET devices 404, 406, and 408 are connected to a ground node.

MOSFET device 402 is selected such that it mirrors the value of current flow through MOSFET device M₁₅ divided by a factor m. As a result, the current flow through MOSFET device 402 is I₁₅/m, and the current flows through MOSFET devices 404, 406, and 408 are I₁₄/M, I_{L}/m, and I_{L}/m, respectively. Accordingly, the circuit 400 generates the current source I_{L}/m. In one embodiment, m may be selected to be a value of 32. In other embodiments, m may be selected to be other suitable values.

FIG. 5 is a circuit diagram illustrating an embodiment of bias circuit 306 as shown in FIG. 3. Bias circuit 306 comprises a master calibrated current source V_{reg}/R, a resistive element R, a p-channel MOSFET device M_{big3}, and current sources connected to the drain and source connections of MOSFET device M_{big3}. MOSFET device M_{big3} is a relatively large device such that the source to gate voltage approaches the threshold voltage V_{T}. Accordingly, the bias voltage V_{bias} at the gate of MOSFET device M₁₄ is equal to the regulated voltage V_{reg} (i.e., R*(V_{reg}/R)) minus the threshold voltage V_{T}.

Referring back to FIG. 3, the current source V_{reg}/nR may be derived using the master calibrated current source V_{reg}/R and a current mirror circuit (not shown) which includes MOSFET devices selected such that the resulting current is V_{reg}/nR.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A voltage regulator configured to provide a regulated voltage to a load having a first conductance, the voltage regulator comprising:
a feedback circuit configured to generate the regulated voltage; and
a frequency compensation circuit comprising a first MOSFET device having a second conductance;
wherein the frequency compensation circuit is configured to operate the first MOSFET device so that the second conductance varies in response to the first conductance of the load.

2. The voltage regulator of claim 1 wherein the feedback circuit comprises a second MOSFET device having a transconductance, wherein the frequency compensation circuit comprises a third MOSFET device having a third conductance, and wherein the frequency compensation circuit is configured to operate the third MOSFET device so that the third conductance varies in response to the transconductance of the second MOSFET device.

3. The voltage regulator of claim 2 wherein the frequency compensation circuit comprises a first bias circuit and a second bias circuit, wherein the first bias circuit is configured to provide a first voltage to the third MOSFET device to cause the third conductance to vary in response to the transconductance of the second MOSFET device, and wherein the second bias circuit is configured to provide a second voltage to the first MOSFET device to cause the second conductance to vary in response to the first conductance.

4. The voltage regulator of claim 3 wherein the first bias circuit comprises a fourth MOSFET device having a gate connection and a drain connection and a current source connected to the gate connection, the drain connection, and a ground node, and wherein the current source is configured to draw a current from the fourth MOSFET device to generate the first voltage.

5. The voltage regulator of claim 3 wherein the second bias circuit comprises a fourth MOSFET device, a fifth MOSFET device, a sixth MOSFET device, a first current source, a second current source, and a resistive element having a first end and a second end, wherein the first current source is configured to draw a first current from the fourth MOSFET device through the resistor to generate a third voltage which is provided to the fifth MOSFET device, and wherein the second current source is configured to draw a second current from the fifth MOSFET device and the sixth MOSFET device to generate the second voltage.

6. The voltage regulator of claim 5 wherein the first current source is proportional to a master generated current source.

7. The voltage regulator of claim 5 wherein the second current source is proportional to a third current drawn by the load.

8. The voltage regulator of claim 2 wherein the feedback circuit further comprises a bias circuit configured to provide a bias voltage to the second MOSFET device to control a feedback current though the second MOSFET device.

9. The voltage regulator of claim 2 wherein the feedback circuit further comprises a fourth MOSFET device, and wherein the fourth MOSFET device is configured to provide a load current to the load and the feedback current to the second MOSFET device.

10. The voltage regulator of claim 9 wherein the frequency compensation circuit further comprises a capacitive element having a first end connected to the fourth MOSFET device and a second end connected to the first MOSFET device and the third MOSFET device.

11. A method performed by a voltage regulator comprising:
providing a regulated voltage to a load having a first conductance; and
compensating for first variations in the first conductance of the load.

12. The method of claim 11 further comprising:
compensating for the first variations in the first conductance of the load by causing a second conductance of a first MOSFET device to track the first conductance.

13. The method of claim 12 further comprising:
providing a first biasing voltage associated with a current drawn by the load to the first MOSFET device.

14. The method of claim 12 further comprising:
compensating for second variations in a transconductance of a portion of the voltage regulator.

15. The method of claim 14 further comprising:
compensating for the second variations in the transconductance of the portion of the voltage regulator by causing a third conductance of a second MOSFET device to track the transconductance.

16. The method of claim 15 further comprising:
providing a second biasing voltage associated with a current drawn by the portion of the voltage regulator to the second MOSFET device.

17. A system comprising:
a functional unit having a first conductance; and
a voltage regulator comprising:
a first circuit configured to provide a regulated voltage to the functional unit; and
a second circuit comprising a first MOSFET device having a second conductance;
wherein the second circuit is configured to operate the first MOSFET device so that the second conductance tracks the first conductance of the functional unit.

18. The system of claim 17 further comprising:
a transceiver that comprises the functional unit.

19. The system of claim 18 wherein the transceiver is configured for use in a Global System for Mobile Communications (GSM) network.

20. The system of claim 17 wherein the second circuit is configured to operate the first MOSFET device in a linear region of the first MOSFET device.

21. The system of claim 17 wherein the second circuit is configured to provide a voltage to the first MOSFET device to cause the second conductance to track the first conductance of the functional unit.

22. The system of claim 21 wherein the second circuit comprises a first current source configured to generate a first current that is proportional to a second current provided to the functional unit, and wherein the second circuit is configured to generate the voltage using the first current.

23. The system of claim 22 wherein the second circuit comprises a second current source configured to generate a third current that is proportional to a third current generated by a master calibrated current source, and wherein the second circuit is configured to generate the voltage responsive to the second current.

24. The system of claim 17 wherein the first conductance varies over time.

25. The system of claim 17 wherein the first circuit comprises a second MOSFET device having a transconductance, wherein the second circuit comprises a third MOSFET device having a third conductance, and wherein the second circuit is configured to operate the third MOSFET device so that the third conductance varies in response to the transconductance of the second MOSFET device.

26. A voltage regulator for providing a regulated voltage to a load having a first conductance comprising:
a circuit configured to provide the regulated voltage to the load;
first means for generating a second conductance;
second means for operating the first means so that the second conductance tracks the first conductance of the load.

27. The voltage regulator of claim 26 wherein the second means includes third means for providing a voltage to the first means to cause the second conductance to track the first conductance of the load.

28. The voltage regulator of claim 26 wherein the first conductance of the load varies over time.

29. The voltage regulator of claim 26 wherein the circuit comprises a first MOSFET device having a transconductance, and further comprising:
third means for generating a third conductance; and
fourth means for operating the third means so that the third conductance tracks the transconductance of the first MOSFET device.

30. The voltage regulator of claim 29 wherein the fourth means includes fifth means for providing a voltage to the third means to cause the third conductance to track the transconductance of the first MOSFET device.

31. The voltage regulator of claim 29 wherein the circuit is configured to provide a bias voltage to the first MOSFET device to control a feedback current though the first MOSFET device.

32. The voltage regulator of claim 29 wherein the circuit further comprises a second MOSFET device, and wherein the second MOSFET device is configured to provide a load current to the load and the feedback current to the first MOSFET device.

33. The voltage regulator of claim 29 wherein the first means comprises a second MOSFET device and wherein the third means comprises a third MOSFET device.

34. The voltage regulator of claim 33 wherein the second means is for operating the first means in a linear region of the second MOSFET device, and wherein the fourth means is for operating the third means in a linear region of the third MOSFET device.
